(19) United States
(12) Patent Application Publication
(10) Pub. No.: US 2013/0014557 A1
(43) Pub. Date: Jan. 17, 2013

(54) Apparatus and Method for Testing Solar Panel

(71) Applicant: Kun Ta Lee, Taipei Hsien (TW)

(72) Inventor: Kun Ta Lee, Taipei Hsien (TW)

(21) Appl. No.: 13/246,912

(22) Filed: Sep. 28, 2011

(30) Foreign Application Priority Data
Jul. 15, 2011 (TW) 100125233

(51) Int. Cl. G01N 3/30

(52) U.S. Cl. 73/12.01

(57) ABSTRACT

A testing apparatus for testing a solar panel is provided. The testing apparatus includes at least one sensor, at least one impact hammer and at least one adsorbing element. The testing apparatus adsorbs the solar panel with the at least one adsorbing element and the at least one sensor is disposed on the solar panel. At least one vibration is produced when the at least one impact hammer hits the solar panel. The at least one vibration is received and transformed into at least one digital signal by the at least one sensor. The at least one digital signal is then compared with a database to determine the yield of the solar panel.

This application claims priority to Taiwan Patent Application No. 100125233 filed on Jul. 15, 2011.

### CROSS-REFERENCES TO RELATED APPLICATIONS

Not applicable.

### BACKGROUND OF THE INVENTION

1. Field of the Invention

The present invention relates to a testing apparatus and a method for testing a solar panel, and more particularly, to a testing apparatus and a method that uses an impact hammer to elicit a vibration from hitting a solar panel and then measuring the vibration.

2. Descriptions of the Related Art

In conventional manufacturing processes of producing solar panels, the solar panels must be subjected to a testing procedure before delivery to determine quality of the solar panel products. Testing items mainly involve testing the surfaces or the interior of the solar panels for any micro-cracks, material defects, sintering waves, contaminations or circuit disconnections. Out of all these testing items, the material defects, sintering waves and contaminations have the greatest effect on the converting efficiency of the solar panels, so a method in which these defects can be quickly detected and recovered is important.

There are mainly two testing approaches that are conventionally used in the art: the electric testing and the appearance defective inspection. The electric testing is mostly accomplished through electroluminescence (EL) in the following way: a forward current is applied to a solar panel so that near-infrared light rays are radiated by the solar panel in response to the current; then, a light emission image of the surface of the solar panel is captured by a photographic apparatus to check whether streaks on the solar panel are defects. Thereby, the yield of the solar panels can be determined However, although this testing approach can improve the testing efficiency and overcome most of the problems associated with the testing when being applied to monocrystalline solar panels, and it is difficult for human eyes and devices to make a determination when this testing approach is applied to polycrystalline solar panels due to the nature of this testing approach and the complex crystalline compositions.

Accordingly, an urgent need exists in the art to provide a solution capable of improving the efficiency of testing a solar panel to accomplish the test quickly.

### SUMMARY OF THE INVENTION

An objective of the present invention is to provide a testing apparatus and a method for testing a solar panel, which can quickly test the solar panel to improve the testing efficiency.

Another objective of the present invention is to provide a testing apparatus and a method for testing a solar panel, which can be applied to polycrystalline solar panels to effectively determine the yield of the polycrystalline solar panels.

To achieve the aforesaid objective, the present invention provides a testing apparatus for testing a solar panel, which comprises at least one sensor, at least one impact hammer and at least one adsorbing element. The solar panel is adsorbed by the at least one adsorbing element, and the at least one sensor that is disposed on the solar panel. The at least one impact hammer is used for hitting the solar panel to produce at least one vibration, which is then received and transformed by the at least one sensor into at least one digital signal. Then, the yield of the solar panel is determined by comparing at least one digital signal with a database.

The present invention further provides a method for testing a solar panel, which comprises the following steps: hitting the solar panel to produce at least one vibration; and transforming the at least one vibration into at least one digital signal for output. This method is able to determine whether the solar panel is a qualified product by means of a vibration.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of the present invention;

FIG. 2A is a schematic graph illustrating a vibration signal of qualified products according to the first embodiment of the present invention;

FIG. 2B is a schematic graph illustrating a vibration signal of a defective product according to the first embodiment of the present invention;

FIG. 3 is a schematic view of a second embodiment of the present invention; and

FIG. 4 is a schematic view illustrating a procedure of testing a solar panel according to the present invention.

### DESCRIPTION OF THE PREFERRED EMBODIMENT

The present invention relates to a testing apparatus for testing a solar panel. The testing apparatus comprises at least one adsorbing element, at least one impact hammer and at least one sensor. The at least one sensor is disposed on a center of the solar panel, and the at least one adsorbing element is disposed uniformly with respect to the center of the solar panel to adsorb and hold the solar panel. The at least one impact hammer is adapted to hit the solar panel to produce at least one vibration, which is then received and transformed by the at least one sensor into at least one digital signal for output. Then, the yield of the solar panel can be determined by comparing the at least one digital signal with a database.

Hereinbelow, a first embodiment of the testing apparatus of the present invention will be described.

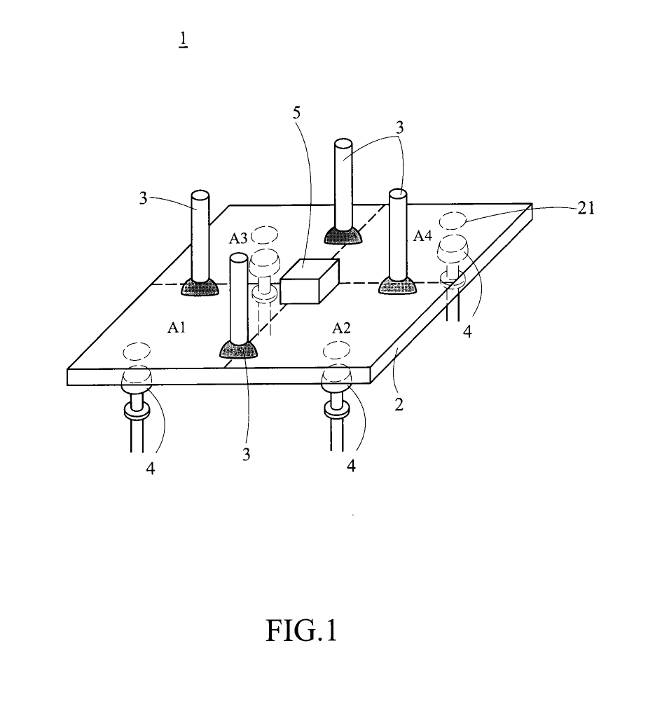

As shown in FIG. 1, in the first embodiment of the testing apparatus 1 of the present invention, the at least one adsorbing element is implemented as four adsorbing elements 3, the at least one impact hammer is implemented as four impact hammers 4, and the at least one sensor is implemented as one sensor 5. To avoid the generation of a turning moment when the solar panel 2 is hit, the four adsorbing elements 3 are disposed uniformly with respect to the center of the solar panel 2. Additionally, four impact points 21 produced when the impact hammers 4 hit the solar panel 2 are further depicted in FIG. 1.

More specifically, prior to the aforesaid testing procedure, the tester may use the impact hammers to hit a plurality of qualified solar panels to establish a database which stores the digital signal parameters for determining the yield of the solar panel 2. Then, the database can be used as a reference for subsequent comparison. Accordingly, after the four impact hammers 4 of the first embodiment hit the solar panel 2 at the four impact points 21, the vibrations produced are transformed by the sensor 5 into a corresponding digital signal and transmitted to the database for comparison.

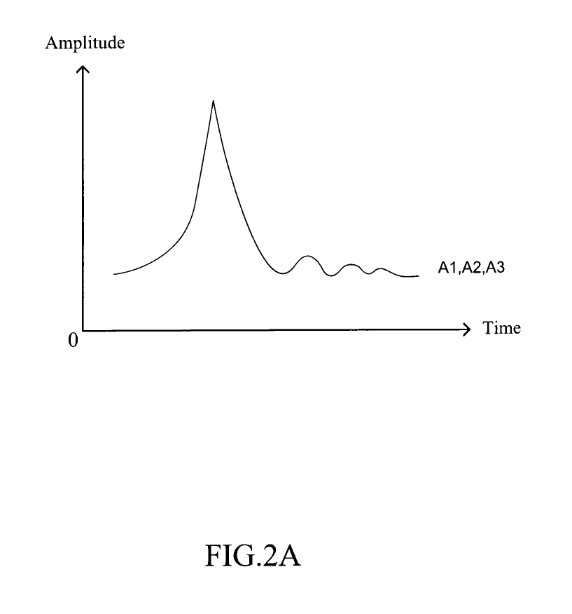

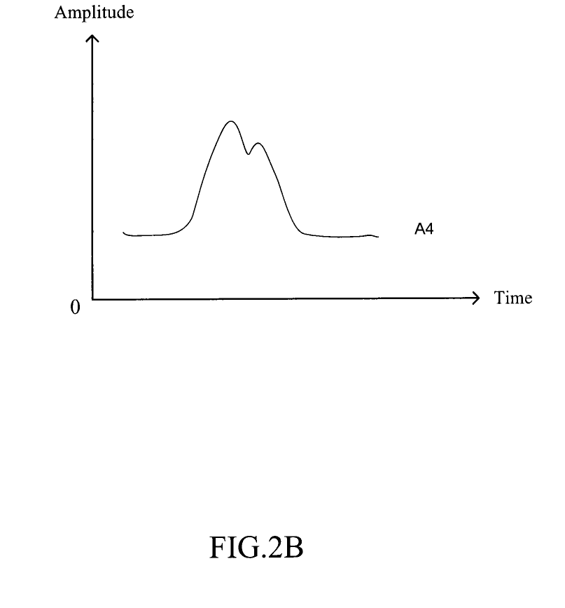

From the database established by using the impact hammers to hit qualified products, a vibration signal of qualified products as shown in FIG. 2A can be obtained for use as a reference in subsequent impact testing. For example, if a graph of a digital signal generated by a solar panel 2 after being hit substantially coincides with the graph shown in FIG. 2A, it can be determined that the solar panel 2 is a qualified product. Conversely, if the graph of the digital signal generated by the solar panel 2 after being hit is significantly different as shown in FIG. 2B, then it can be determined that the solar panel 2 is a defective product. Furthermore, with reference to FIG. 1, if the graphs generated by using the impact hammers to hit the solar panel 2 at blocks A1, A2, A3 and A4 respectively are all substantially similar to what is shown in FIG. 2A, then it can be determined that all the A1, A2, A3 and A4 blocks are qualified; conversely, if the graph generated for any of the blocks A1, A2, A3 and A4 is different from what is shown in FIG. 2A (e.g., as shown in FIG. 2B), then it can be determined that the corresponding block is defective. It shall be appreciated that because digital signals generated by solar panels of different sizes, specifications and materials after being hit vary from each other, the graphs that are drawn also vary accordingly; therefore, the graphs shown in FIGS. 2A and 2B are only provided as an example but are not intended to limit the scope of the present invention.

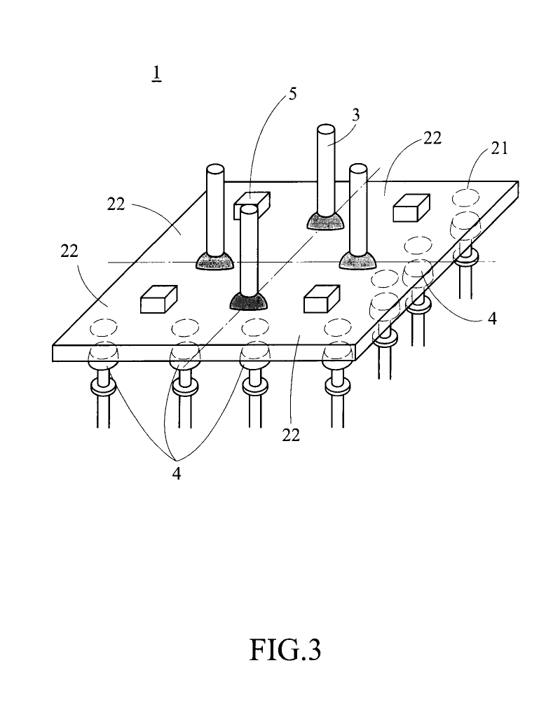

FIG. 3 depicts a second embodiment of the present invention. The second embodiment differs from the first embodiment in that the solar panel 2 is divided into four equal areas 22 and the adsorbing elements 3 are still disposed in the same way as those of the first embodiment. The numbers of the impact hammers 4 and the sensors 5 are both different from the first embodiment.

More specifically, the four impact hammers 4 and a sensor 5 are disposed in each of the equal areas 22 in the second embodiment; however, for ease of understanding, only a part of the impact hammers 4 are depicted in FIG. 3. In the second embodiment, the four impact hammers 4 on each of the equal areas 22 are disposed uniformly with respect to the sensor 5, and impact points 21 are generated correspondingly when the impact hammers 4 hit the solar panel 2. Because this practice of dividing the solar panel 2 into equal areas 22 for testing allows for testing of a specific block of the solar panel 2, it can help to more accurately determine which block of the solar panel 2 is defective so that the solar panel 2 can be used for other purposes after the defective block is removed, thus avoiding waste of the original materials.

As described above, the tester may also divide the solar panel 2 into eight or sixteen equal areas for testing depending on practical needs. However, it shall be noted that at least one impact hammer 4 and at least one sensor 5 must be used for each of the equal areas.

Additionally, although the adsorbing elements 3 and the impact hammers 4 are depicted to be disposed above and below the solar panel 2 respectively in both the first embodiment and the second embodiment, they are not limited thereto. In other words, apart from being disposed on opposite sides of the solar panel 2 respectively, the adsorbing elements 3 and the impact hammers 4 may also be disposed on the top side of the solar panel 2 simultaneously or on the bottom side simultaneously to accomplish the testing procedure of the present invention.

It shall be appreciated that no matter which arrangement is adopted, the number of the adsorbing elements 3 and the impact hammers 4 as well as the way in which they are disposed on the solar panel 2 shall be the same as when the database is initially established to ensure accuracy in the determination of the yield. Furthermore, apart from hitting the solar panel 2 synchronously, the impact hammers 4 may also hit the solar panel 2 sequentially when the vibration data is measured. Obviously, the positions of the sensors 5 may also be changed by those of ordinary skill in the art to the four corners or the four edges of the solar panel 2, but are not limited to what is described above. In the present invention, the adsorbing elements 3 are preferably suckers or other equivalent devices, the impact hammers 4 are preferably miniaturized impact hammers, and the sensors 5 are preferably accelerometers or other equivalent devices.

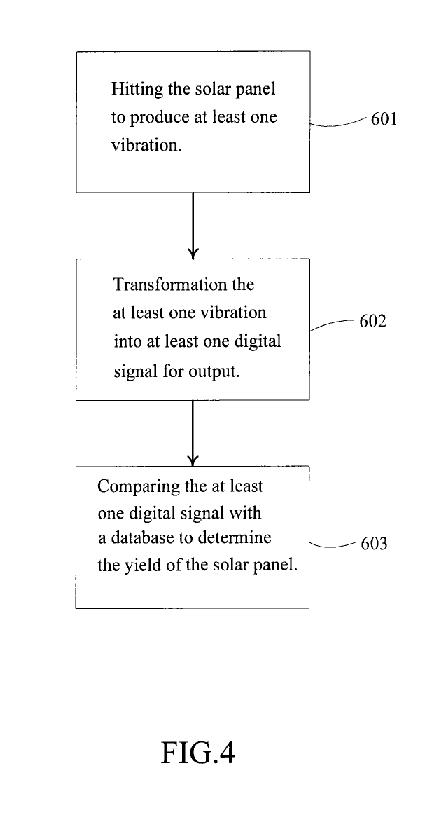

FIG. 4 is a flowchart of a method for testing a solar panel 2 according to the present invention. First, as shown in step 601, the solar panel 2 is hit to produce at least one vibration. Next, as shown in step 602, the at least one vibration produced in step 601 is transformed into at least one digital signal for output. Finally, as shown in step 603, the at least one digital signal is compared with data in a database to determine the yield of the solar panel 2.

According to the above descriptions, at least one impact hammer 4 is used to hit the solar panel 2 to produce at least one vibration, then the at least one vibration is transformed into at least one digital signal, and the at least one digital signal is compared with the database to determine the yield of the whole solar panel 2 or a specific area of the solar panel 2. Thus, by use of the testing apparatus and the method of the present invention, the efficiency of determining defects of polycrystalline solar panels is improved and the possibility of making a false determination is obviated.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A testing apparatus for testing a solar panel, comprising:
at least one sensor disposed on the solar panel;
at least one impact hammer; and
at least one adsorbing element for adsorbing the solar panel;
wherein the at least one adsorbing element is adapted to steady the solar panel, the at least one impact hammer is used for hitting the solar panel to produce at least one vibration, and the at least one sensor is adapted to receive the at least one vibration and transform the at least one vibration into at least one digital signal.

2. The testing apparatus as claimed in claim 1, wherein the at least one impact hammer is four impacting hammers, four impact points are produced as the four impacting hammers hit the solar panel, and the four impact points are disposed symmetrically on the solar panel.

3. The testing apparatus as claimed in claim 2, wherein the at least one sensor is an accelerometer disposed on a center of the solar panel.

4. The testing apparatus as claimed in claim 3, wherein the at least one adsorbing element is four suckers disposed uniformly along the center of the solar panel.

5. The testing apparatus as claimed in claim 1, wherein the at least one sensor is an accelerometer disposed on an edge of the solar panel.

6. The testing apparatus as claimed in claim 1, wherein the solar panel is divided into a plurality of equal areas, and at least one impacting hammer and at least one sensor are disposed on each of the equal areas.

7. The testing apparatus as claimed in claim 5, wherein the at least one sensor is an accelerometer disposed on a center of each of the equal areas.

8. The testing apparatus as claimed in claim 1, further comprising a signal converter for transforming the at least one vibration received from the at least one sensor into at least one digital signal.

9. A method for testing a solar panel, comprising:
(a) hitting the solar panel to produce at least one vibration; and
(b) transforming the at least one vibration into at least one digital signal for output.

10. The method as claimed in claim 9, further comprising:
(c) comparing the at least one digital signal with a database to determine the yield of the solar panel.
